(19) United States
(12) Patent Application Publication
(10) Pub. No.: US 2004/0083188 A1
(43) Pub. Date: Apr. 29, 2004

(54) System and method for managing costs of employing hardware, sofware and service

(76) Inventors: Chung-I Lee, Tu-Chen (TW); YeKoo Wang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/283,734

(22) Filed: Oct. 29, 2002

(51) Int. Cl. G06F 17/60

(52) U.S. Cl. 705/400; 705/1

(57) ABSTRACT

A system for managing costs of employing hardware, software, and service includes an application server (10), an original database (14), and a gross cost database (16). The original database is for storing original data on hardware and software, maintenance, printing, web, and development. The gross cost database is for storing original and analyzed cost data on hardware and software, maintenance, printing, web, and development. The application server includes a hardware and software cost module (101), a maintenance cost module (102), a printing cost module (103), a web cost module (104), a development cost module (105), and a statistics and analysis module (106). The five cost modules are respectively for calculating costs of hardware and software, maintenance, printing, web and development, and storing the results in the gross cost database. The statistics and analysis module is for analyzing all the above-mentioned costs, and storing the results in the gross cost database.

### BACKGROUND OF THE INVENTION

1. Field of the Invention

The present invention relates to a system and method for managing costs of an enterprise, and more particularly to a system and method for managing and analyzing costs of employing hardware, software and service.

2. Description of Related Art

Nowadays, with computer and networking technology becoming increasingly popular, the cost of using computers, peripherals and network equipment is becoming a significant proportion of total operating costs of many corporations. It is becoming increasingly necessary to effectively monitor and control these burgeoning costs.

There are already well-developed technologies for monitoring printing costs of a corporation. For example, U.S. Pat. No. 6,064,838 discloses a printing system that can determine printing costs beforehand. The system includes: an input unit for entering a printing job; a calculator for calculating a copying cost according to the input printing job; a display for displaying the calculated copying cost; and a controller for allowing modification of a displayed printing job, and for permitting a printing operation after confirming that there is no modification in the displayed printing job. The cost of a desired printing job can be displayed prior to a print out operation, so that modification of the printing mode can be performed. Since a print out operation is permitted only after confirming the display of the copying cost, the expense required for printing can be determined in advance. Another example is a Papercut monitoring system provided by Oscura Software. This system is for monitoring the cost of employing web and printing facilities. However, in addition to printing costs, there are many other kinds of costs incurred when a company employs computers and peripherals. Such other costs include the cost of hardware, software, service, maintenance and development. These other costs also need monitoring and control.

Accordingly, what is needed is a system and method that can manage all costs associated with employing hardware, software and service.

### SUMMARY OF THE INVENTION

An object of the present invention is to provide a system and method for managing all costs associated with employing hardware, software and service.

To achieve the above object, the present invention provides a system and method for managing costs of employing hardware, software, and service. A preferred embodiment of the system comprises an application server, an original database, and a gross cost database. The original database is for storing original data on hardware and software, maintenance, printing, web, and development. The gross cost database is for storing all kinds of original and analyzed cost data on hardware and software, maintenance, printing, web, and development. The application server comprises a hardware and software cost module, a maintenance cost module, a printing cost module, a web cost module, a development cost module, and a statistics and analysis module. The hardware and software cost module is for sending a command to personal computers to search for information about specified hardware and software, generating a cost of the specified hardware and software according to the information obtained by the search, and storing the cost in a gross cost database. The maintenance cost module is for extracting information from a maintenance list of the original database, generating a maintenance cost, and sending the maintenance cost to the gross cost database. The printing cost module is for extracting information from a printing list of the original database, generating a printing cost, and sending the printing cost to the gross cost database. The web cost module is for extracting information from a web list of the original database, generating a web cost, and sending the web cost to the gross cost database. The development cost module is for extracting information from a development list of the original database, generating a development cost, and sending the development cost to the gross cost database. The statistics and analysis module is for extracting the costs of hardware and software, maintenance, printing, web and development from the gross cost database, analyzing the costs, and storing the results of analysis in the gross cost database.

A preferred embodiment of the method for managing costs of employing hardware, software, and service comprises the steps of: sending a search command to personal computers for information about hardware and software; searching according to the search command, and sending information obtained to a hardware and software cost module; calculating depreciation of hardware and software, and storing the results of the calculation in a gross cost database; extracting information on maintenance, printing, web and development, calculating costs of maintenance, printing, web and development, and storing results of the calculation in the gross cost database; and calculating total costs and storing results of the calculation in the gross cost database.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a schematic illustration of hardware and software infrastructure of a system for managing costs of employing hardware, software and service in accordance with a preferred embodiment of the present invention;

FIGS. 2, 3, 4, 5, 6 and 7 illustrate various original data forms used in the system of FIG. 1;

FIG. 8 is a flow chart of analyzing costs of employing hardware, software and service in accordance with the present invention.

### DETAILED DESCRIPTION OF THE INVENTION

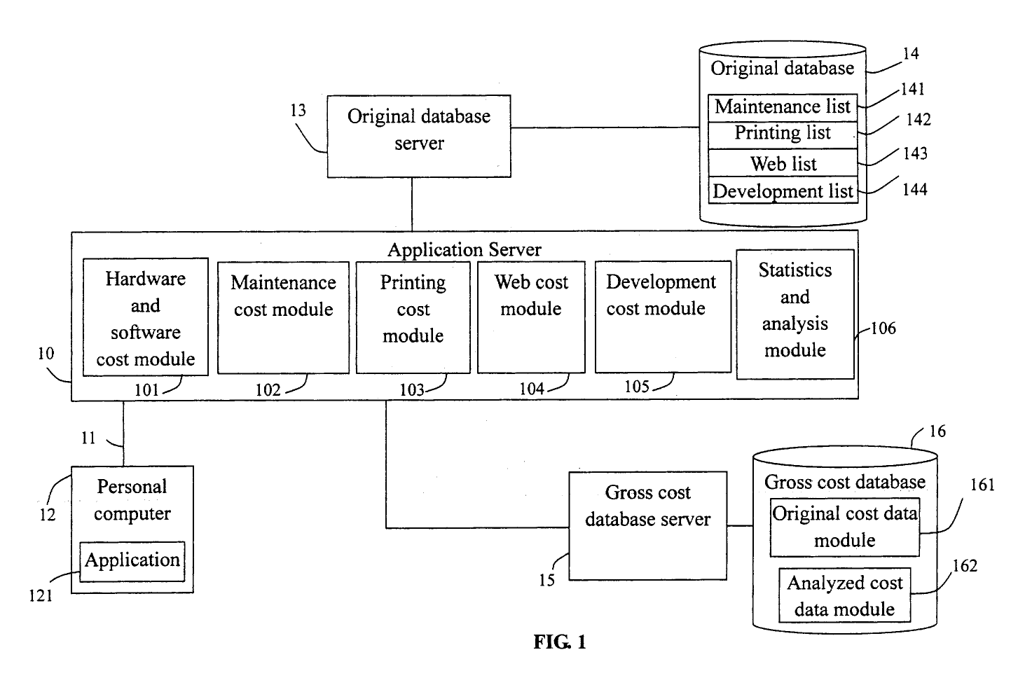

FIG. 1 is a schematic illustration of hardware and software infrastructure of a system for managing costs of employing hardware, software and service in accordance with a preferred embodiment of the present invention. The system comprises an application server 10, an original database 14, a gross cost database 16, and a plurality of personal computers 12 (only one shown). The original database 14 is for storing original data. The original data include a maintenance list 141, a printing list 142, a web list 143, and a development list 144. The maintenance list 141 is for storing relevant information about each maintenance service performed by a computer engineer in an enterprise. As soon as the computer engineer finishes maintenance, he/she inputs relevant information to the maintenance list 141. The relevant information includes period, maintenance engineer, maintenance time, the object of the maintenance, and the department in charge of the object. The printing list 142 is for storing relevant information about each printing service performed for the enterprise. The web list 143 is for storing information about the network flow of personal computers in the enterprise over set periods of time. The development list 144 is for storing information about development of hardware and software for the enterprise over set periods of time. The original database server 13 is for retrieving information about maintenance, printing, web and development from the original database 14.

The gross cost database 16 comprises an original cost data module 161, and an analyzed cost data module 162. The original cost data module 161 is for storing all kinds of original cost data, including hardware and software costs, maintenance costs, printing costs, web costs and development costs. The analyzed cost data module 162 is for storing analyzed cost data obtained from the application server 10. The gross cost database server 15 is for storing data in and retrieving data from the original cost data module 161 and the analyzed cost data module 162.

The application server 10 is for providing a system administrator with an operating platform. The application server 10 comprises a hardware and software cost module 101, a maintenance cost module 102, a printing cost module 103, a web cost module 104, a development cost module 105, and a statistics and analysis module 106. The hardware and software cost module 101 is for sending a command to personal computers 12 to search for information about specified hardware and software, generating a cost of the specified hardware and software according to the information obtained by the search, and storing the hardware and software cost in the original cost data module 161 of the gross cost database 16. The maintenance cost module 102 is for extracting information from the maintenance list 141 of the original database 14, generating a maintenance cost and sending the maintenance cost to the original cost data module 161 of the gross cost database 16. The printing cost module 103 is for extracting information from the printing list 142 of the original database 14, generating a printing cost, and sending the printing cost to the original cost data module 161 of the gross cost database 16. The web cost module 104 is for extracting information from the web list 143 of the original database 14, generating a web cost, and sending the web cost to the original cost data module 161 of the gross cost database 16. The development cost module 105 is for extracting information from the development list 144 of the original database 14, generating a development cost, and sending the development cost to the original cost data module 161 of the gross cost database 16. The statistics and analysis module 106 is for extracting the costs of hardware and software, maintenance, printing, web and development from the original cost data module 161, summarizing and analyzing the costs, and storing the results of summarizing and analysis in the analyzed cost data module 162 of the gross cost database 16.

The personal computers 12 are located in different departments of the enterprise, and controlled by the application server 10. Each personal computer 12 is equipped with an application 121. The application 121 is for executing a received command to search for information about specified hardware and software, and sending the information obtained to the application server 10. The application 121 obtains information about hardware via the Microsoft WSI Scripting V1.1 library. Such information includes processor, memory, personal computer (PC) name, and Internet protocol (IP) address. The application 121 obtains information about software by searching setup information in registration lists of the personal computers 12.

The application server 10 and personal computers 12 are connected via a network 11. In the preferred embodiment, the network 11 is an intranet or the Internet. Information is transmitted between the application server 10 and personal computers 12 via User Datagram Protocol (UDP) or Transfer Control Protocol (TCP).

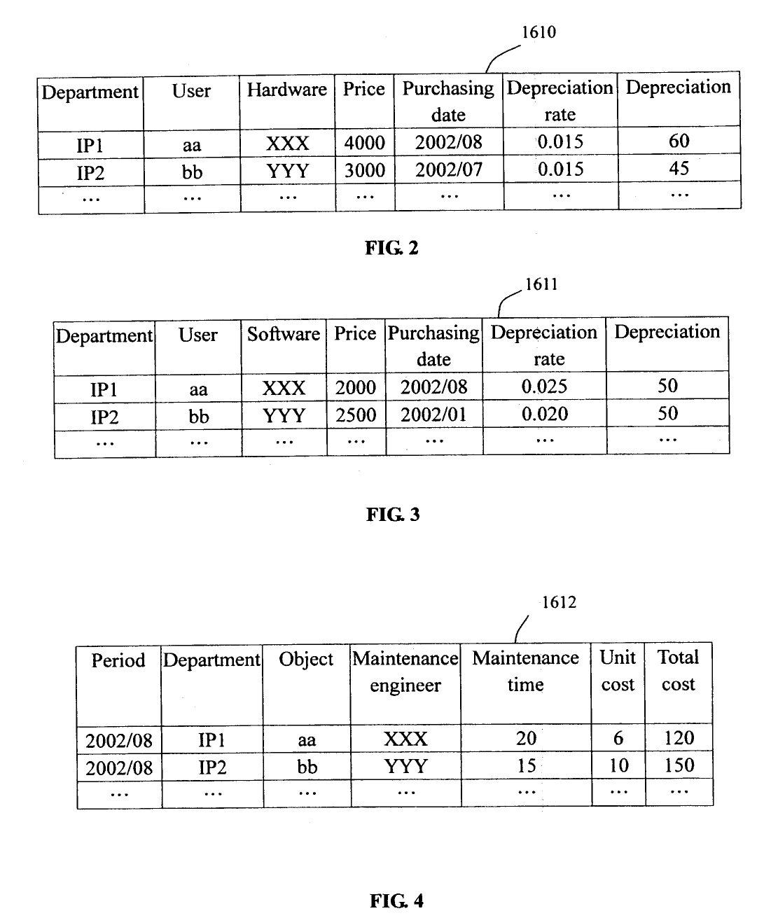

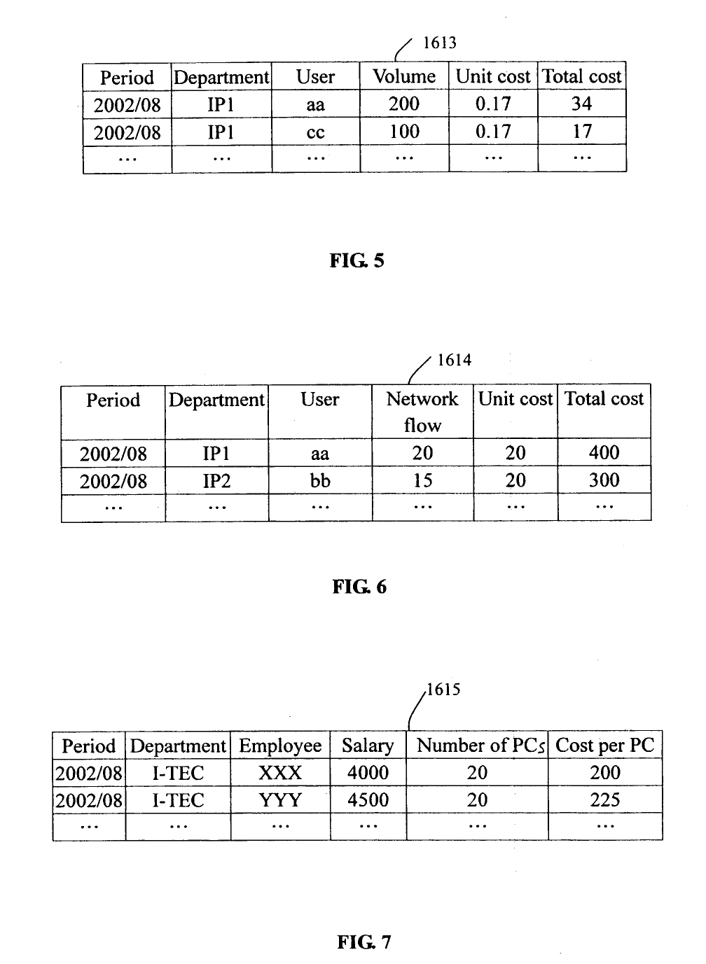

FIGS. 2, 3, 4, 5, 6 and 7 illustrate original data forms used in the original cost data module 161 of the system of FIG. 1. FIG. 2 is a hardware cost form 1610, FIG. 3 is a software cost form 1611, FIG. 4 is a maintenance cost form 1612, FIG. 5 is a printing cost form 1613, FIG. 6 is a web cost form 1614, and FIG. 7 is a development cost form 1615. After receiving information about hardware from the applications 121 of the personal computers 12, the hardware and software cost module 101 generates the hardware cost form 1610, and stores the hardware cost form 1610 in the original cost data module 161. The hardware cost form 1610 comprises columns for user's department, user name, hardware, price, purchasing date, depreciation rate, and depreciation. After receiving information about software from the applications 121 of the personal computers 12, the hardware and software cost module 101 generates the software cost form 1611, and stores the software cost form 1611 in the original cost data module 161. The software cost form 1611 comprises columns that are the same as those of the hardware cost form 1610; except instead of a hardware column, there is a software column. The maintenance cost form 1612 comprises columns for time period, the department having the object maintained, the object of the maintenance, maintenance engineer, maintenance time, unit cost, and total cost. The printing cost form 1613 comprises columns for printing period, user's department, user name, printing volume, unit cost, and total cost. The web cost form 1614 comprises columns for time period, user's department, user name, network flow, unit cost, and total cost. The development cost form 1615 comprises columns for time period, department, name and salary of employee (i.e. a development engineer), number of personal computers, and cost per personal computer.

In said six forms 1610-1615, hardware and software costs, maintenance costs, printing costs, web costs and development costs are respectively calculated by the five cost modules 101-105 of the application server 10, based on data obtained from the original database 14. In the preferred embodiment of the present invention, the costs of hardware and software are their respective depreciations. Referring to FIG. 2, to calculate a total cost of hardware used by ‘aa’ for one month, the hardware and software cost module 101 multiplies the hardware's price by its monthly depreciation rate; that is, 4000*0.015=60. Referring to FIG. 3, a total cost of software used by ‘aa’ for one month is calculated in the same way. Referring to FIGS. 4, 5 and 6, similarly, a total maintenance cost for one month is calculated by multiplying a unit maintenance cost by a maintenance time of a maintenance engineer, a total printing cost for one month is calculated by multiplying a unit cost by a printing volume for the period, and a total web cost for one month is calculated by multiplying a unit cost by a network flow for the period. Referring to FIG. 7, a development cost per personal computer is calculated by adding all salaries of development engineers, and dividing such sub-total by the number of personal computers 12.

The above six categories of costs corresponding to said six forms 1610-1615 are calculated for each personal computer 12. The statistics and analysis module 106 further calculates a total of all such costs by personal computer 12, by category of cost, and by department.

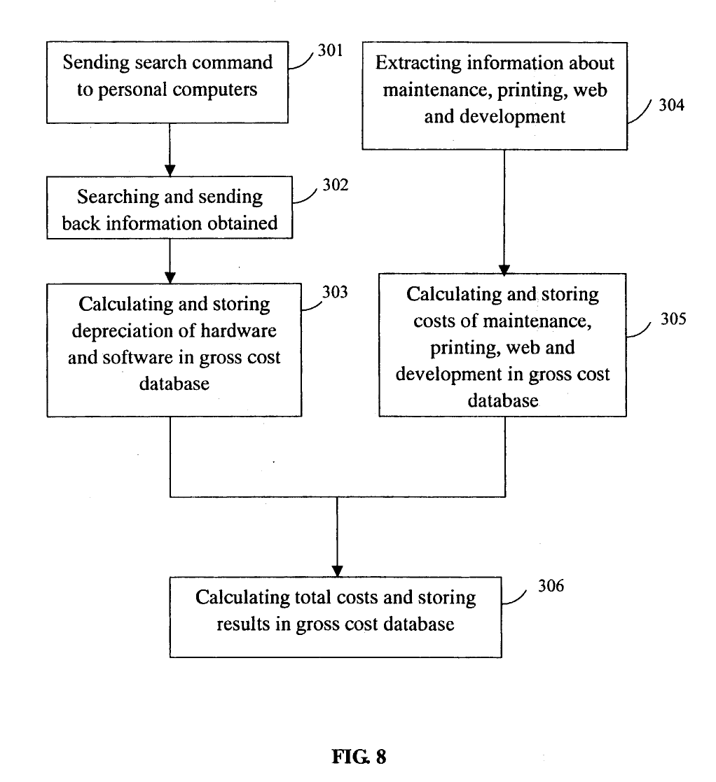

FIG. 8 is a flow chart of analyzing costs of employing hardware, software and service in accordance with the present invention. In step 301, the hardware and software cost module 101 sends a search command to personal computers 12 for information about hardware and software. In step 302, the applications 121 of the personal computers 12 execute the search command, and send information obtained to the hardware and software cost module 101. In step 303, the hardware and software cost module 101 calculates and stores depreciation of hardware and software in the original cost data module 161. In step 304, the maintenance cost module 102, the printing cost module 103, the web cost module 104 and the development cost module 105 respectively extract information about maintenance, printing, web and development from the respective lists 141-144 of the original database 14. In step 305, the maintenance cost module 102, the printing cost module 103, the web cost module 104 and the development cost module 105 respectively calculate and store costs of maintenance, printing, web and development in the original cost data module 161. In step 306, the statistics and analysis module 106 calculates a total of depreciation of hardware and software and costs of maintenance, printing, web and development by personal computer 12, by category of cost, and by department, and stores the results in the analyzed cost data module 162. Step 301 does not necessarily occur prior to step 304. That is, it makes no difference whether step 301 or step 304 is performed first in time.

The above-described preferred embodiment of the present invention is to be construed as being illustrative of the present invention and not restrictive. Modification of the preferred embodiment within the spirit of the invention will be apparent to those skilled in the art, and any such modification is included in the scope of the invention as defined by the following claims.

What is claimed is:

1. A system for managing costs of employing hardware, software, and service, the system comprising:
an original database for storing original data;
a gross cost database comprising an original cost data module and an analyzed cost data module;
an application server comprising:
a hardware and software cost module for sending a search command, generating a cost of specified hardware and software according to information obtained by the search, and storing said cost in the gross cost database;
a maintenance cost module for extracting information from the original database, generating a maintenance cost, and sending the maintenance cost to the gross cost database;
a printing cost module for extracting information from the original database, generating a printing cost, and sending the printing cost to the gross cost database;
a web cost module for extracting information from the original database, generating a web cost, and sending the web cost to the gross cost database;
a development cost module for extracting information from the original database, generating a development cost, and sending the development cost to the gross cost database; and
a statistics and analysis module for extracting costs of hardware and software, maintenance, printing, web and development from the gross cost database, analyzing said costs, and storing a result of the analysis in the gross cost database; and
a plurality of personal computers connected with the application server via a network.

2. The system of claim 1, further comprising an original database server for retrieving information from the original database.

3. The system of claim 1, further comprising a gross cost database server for storing data in and retrieving data from the gross cost database.

4. The system of claim 1, wherein the original database comprises a maintenance list for storing information about maintenance service, a printing list for storing information about printing service, a web list for storing information about network flow of personal computers, and a development list for storing information about development of hardware and software.

5. The system of claim 1, wherein the original cost data module includes a hardware cost form, a software cost form, a maintenance cost form, a printing cost form, a web cost form, and a development cost form.

6. The system of claim 1, wherein the analyzed cost data module is for storing analyzed cost data obtained from the statistics and analysis module.

7. The system of claim 1, wherein each of the personal computers comprises an application for executing the search command, and for sending information obtained by the search to the application server.

8. A method for managing costs of employing hardware, software, and service, the method comprising the steps of:
(a) sending a search command to a personal computer for information about hardware and software;
(b) searching according to the search command, and sending information obtained to a hardware and software cost module;
(c) calculating depreciation of hardware and software, and storing result of the calculation in a gross cost database;
(d) extracting information on maintenance, printing, web and development, calculating costs of maintenance, printing, web and development, and storing results of the calculation in the gross cost database; and
(e) calculating total costs and storing a result of the calculation in the gross cost database.

9. The method of claim 8, wherein step (d) can be performed prior to step (a).

10. A method of cost management of information collection via Internet, comprising:
(a) calculating both selected existing hardware and corresponding software costs including depreciation cost;
(b) calculating maintenance cost;
(c) calculating printing cost for paper and ink;
(d) calculating web cost including those derived from information source provider and web service provider;
(e) calculating development cost including integration of said hardware and said software, and self-developing hardware and software used in a system implementing the method; and
(f) recording and analyzing results in steps of (a) through (e).
